(19) United States
(12) Patent Application Publication
(10) Pub. No.: US 2006/0243484 A1
(43) Pub. Date: Nov. 2, 2006

(54) Sealing member and grommet having the same

(75) Inventors: Yasuyoshi Serizawa, Tochigi (JP); Hiroyuki Sasaki, Tochigi (JP); Junichi Yoshizumi, Tochigi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: YAZAKI CORPORATION, Tokyo (JP)

(21) Appl. No.: 11/403,159

(22) Filed: Apr. 13, 2006

(30) Foreign Application Priority Data
Apr. 15, 2005 (JP) 2005-117978

(51) Int. Cl. H02G 3/18; F16L 5/02

(52) U.S. Cl. 174/659; 174/668; 16/2.2

(57) ABSTRACT

A sealing member includes a main body, a lip contacting an opposite member to seal the opposite member to keep watertightness between the grommet main body and the opposite member, and a hollow portion positioned between the main body and the lip. The hollow portion is defined unitarily with the main body and the lip, and the hollow portion has one end and an opposed end that are contiguous with the main body. The sealing member further includes a compensation piece attached in the main body and made of a hard material. The compensation piece has a projection engaged with the hollow portion such that the projection is positioned adjacent to the hollow portion. The lip has a convex surface projecting from the hollow portion toward the opposite member. A grommet having the sealing member is attached to a door of a motor vehicle for preventing a wiring harness arranged between the door and a body of the vehicle from contacting an external liquid, and the lip of the sealing member seals the door to keep watertightness between the door and the sealing member.

### BACKGROUND OF THE INVENTION

1. Field of the Invention

The present invention relates to a sealing member for sealing an opposite member like a door to keep watertightness and a grommet having the sealing member.

2. Related Art

In arrangement of wiring harnesses of a motor vehicle between a main vehicle body and a door, various conventional types of grommets are applied to protect the wiring harnesses from an external liquid such as water, for example as referred in Japanese Patent Application Laid-open NO. 11-20573.

A conventional grommet 100 shown in FIG. 9 has a main body 101 made of a rubber or the like and a protector made of a synthetic resin. The main body 101 unitarily has a plate portion 102 as a sealing member, a tube (not shown), a first lip 103, and a second lip 104. The plate portion 102 is a flat plate attached near a hinge of the door. The tube is a cylindrical body penetrating the plate portion 102.

The first lip 103 is positioned at a periphery of the plate portion 102 so as to abut against the door to seal the door to keep watertightness. The second lip 104 is positioned inside the first lip 103 in the plate portion 102. The second lip 104 spreads outward with gradually increasing divergence in a direction coming apart from the plate portion 102. That is, the second lip 104 is extended from the plate portion 102. The second lip 104 abuts against the door to seal the door to keep watertightness.

The grommet 100 seals a space of the door to keep watertightness by the first lip 103 and the second lip 104, so that the wiring harness with its surrounding tube is protected from external water.

The grommet 100 shown in FIG. 9 has a section in which the second lip 104 is cantilevered from the plate portion 102. Thus, in the conventional grommet 100, when pressurized water enters between the first lip 103 and the door, the water displaces the second lip 104 to disengage it from the door. Accordingly, the grommet 100 can not prevent the pressurized water from entering inside the grommet 100.

In view of the foregoing situation, an object of the invention is to provide a sealing member and a grommet having the sealing member to seal an opposite member for surely preventing incursion of a pressurized water through the sealing member into an inside space of the opposing member.

### SUMMARY OF THE INVENTION

To achieve the foregoing object, an aspect of the present invention is a sealing member, which includes:

a main body,

a lip contacting an opposite member to seal the opposite member to keep watertightness between the main body and the opposite member, and

a hollow portion positioned between the main body and the lip, the hollow portion defined unitarily with the main body and the lip, the hollow portion having one end and an opposed end that are contiguous with the main body.

Thus, each end of the hollow portion presses the lip against the opposite member with the lip therebetween. Since the lip is supported by the hollow portion of a two leg type, the lip can resist to its displacement coming apart from the opposite member more than a conventional lip of a cantilevered type. Therefore, the lip according to the present invention can keep engagement with the opposite member even when pressurized water is acts on the sealing portion with the lip, surely preventing the pressurized water from entering via the sealing member.

Preferably, the sealing member further includes a compensation piece attached in the main body and made of a hard material. The compensation piece has a projection engaged with the hollow portion such that the projection is spaced from an inner surface of the hollow portion, the inner surface positioned in the side of the lip.

A space between the projection and the inner surface of the hollow portion allows resilient deformation of the hollow portion, so that the lip deforms to move from and toward the hollow portion. The comparatively free deformation of the lip provides a contact force uniform over the whole length of the lip. Thus, even a weak point of the lip is prevented from intrusion of the pressurized water. That is, the lip can contact reliably the opposite member over the whole length of the lip. The compensation piece prevents excessive yielding of the lip to adequately contact the opposite member with more reliability.

Preferably, the lip has a convex surface projecting from the hollow portion toward the opposite member.

The convex surface of the lip provides a reduced contact surface against the opposite member so that the lip gives a higher contact pressure per a unit area to the opposite member. Therefore, the lip can contact the opposite member more reliably with ease.

Preferably, a grommet having the sealing member is provided, wherein the grommet is attached to a door of a motor vehicle for preventing a wiring harness arranged between the door and a body of the vehicle from contacting an external liquid, and the lip of the sealing member seals the door to keep watertightness between the door and the sealing member.

The grommet having the sealing member surely prevents pressurized water from entering a protective space of the door.

### BRIEF DESCRIPTION OF THE DRAWINGS

FIG. 1 is a perspective view showing a state in which a grommet of an embodiment according to the present invention is attached to a door;

FIG. 2 is an enlarged perspective view showing the grommet of FIG. 1;

FIG. 3 is an exploded perspective view showing the grommet of FIG. 2;

FIG. 4 is a schematic view partially in section taken along line IV-IV of FIG. 2;

FIG. 5 is an enlarged perspective view showing a compensation piece of the grommet shown in FIG. 1;

FIG. 6 is another perspective view showing the grommet of FIG. 2;

FIG. 7 is a sectional view taken along line VII-VII of FIG. 6;

FIG. 8 is a sectional view showing a state in which the grommet of FIG. 7 is attached to a door; and

FIG. 9 is a sectional view showing a primary configuration of a conventional grommet.

### DETAILED DESCRIPTION OF PREFERRED EMBODIMENT

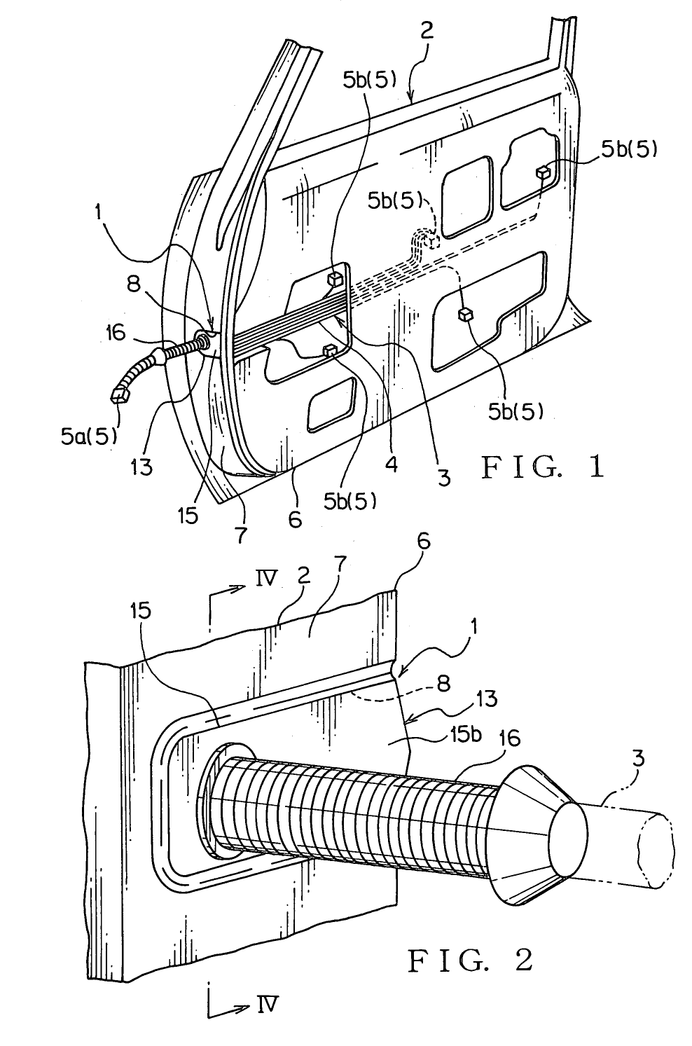

Referring to FIGS. 1 to 8, a grommet of an embodiment according to the present invention will be discussed. A grommet 1 of the embodiment, which is shown in FIG. 1, is a so-called non-penetrating grommet used for arrangement of a wiring harness 3 (FIG. 1) between a main body of a motor vehicle and a door 2 (FIG. 1) pivotally attached to the main body.

The wiring harness 3, as shown in FIG. 1, has a plurality of electrical cables 4 and a plurality of connectors 5. The electrical cable 4 is an insulated one having an electrically conductive core wire and an insulating covering layer. The core wire is a strand made of a metal like copper. The covering layer is made of an insulating synthetic resin and covers the core wire.

The connectors 5 are attached to ends of the electrical cable 4. One 5a of the connectors 5 couples with an associated connector (not shown) of another wiring harness disposed in the main vehicle body. Another connector 5b couples with an associated connector of one of electronic instruments such as a speaker, a switch unit, a door locking unit, and a power window motor.

Thus configured wiring harness 3 supplies various signals and power to the electronic instruments mounted in the door 2 after the connectors 5a, 5b couple with the associated ones. The wiring harness 3 also supplies signals from the switch unit to a wiring harness disposed in the vehicle main body.

The door 2, which is made from a metal plate, has a door panel 6 pivotally attached to the vehicle main body via hinges and a door trim (not shown) secured to the inside of the door panel 6, as shown in FIGS. 1 and 2. The door panel 6 of the door 2 is mounted with several types of electronic instruments including the speaker, the switch unit, the door locking unit, and the power window motor. The door panel 6 corresponds to an opposite member described in claims.

The door panel 6 has a recess 8 in an end surface 7 opposed to the door hinges as shown in FIGS. 1 to 3. The recess 8 is extended straight outward from an inner edge of the end surface 7.

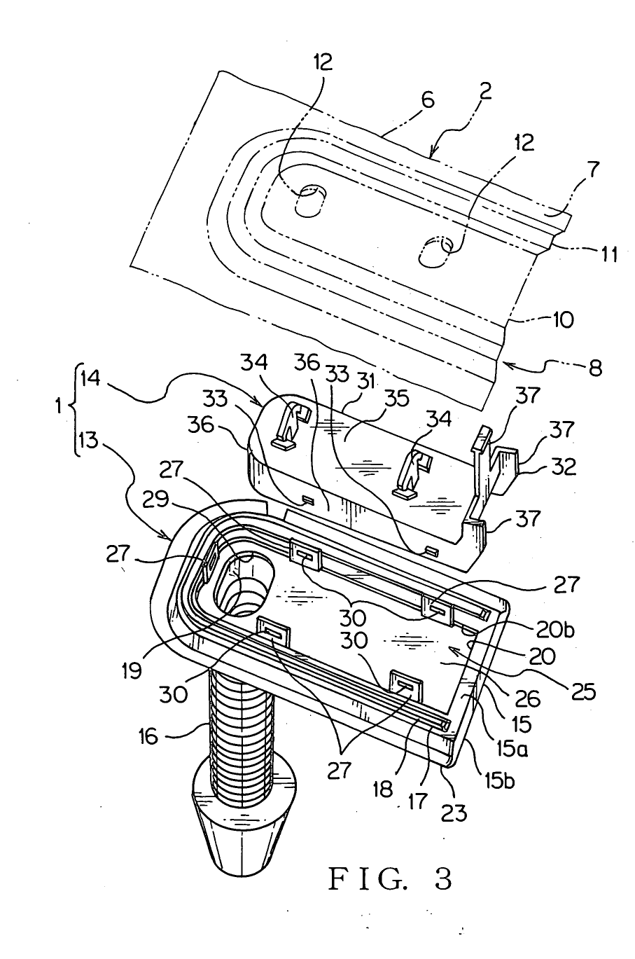

As shown in FIG. 3, the recess 8 has a deep recess 10 for receiving an inner grommet 14 discussed later of the grommet 1 and a shallow recess 11 surrounding the deep recess 10. The deep recess 10 has a depth relative to a basic surface of the end surface 7, which is larger than a depth of the shallow recess 11. The recess 8 is used for attaching the grommet 1 to the door panel.

As shown in FIG. 3, the deep recess 10 has a bottom through which a plurality of holes 12 are formed. There are two holes 12 in the illustrated example. The two holes are spaced from each other in an elongated direction of the recess 8, that is, in an inward direction of the door 2.

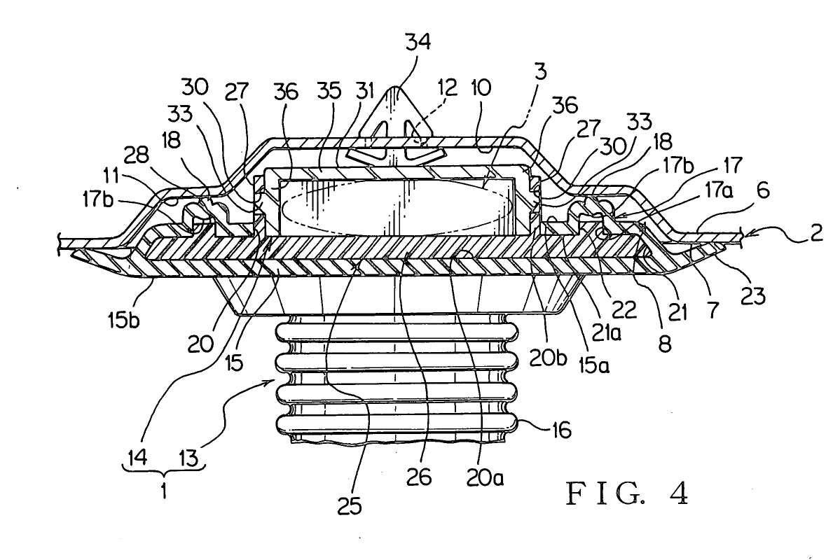

As shown in FIGS. 3 and 4, the grommet 1 has a grommet main body 13 made of a resilient material like rubber as a sealing member and an inner grommet 14 made of a synthetic resin.

As shown in FIGS. 3 and 6, the grommet main body 13 unitarily has a plate portion 15 as a main body, a tube 16 as a cylindrical body, a hollow portion 17, and a lip 18. The plate portion 15 has a plan shape substantially the same as that of the recess 8. The plate portion 15 has an opening 19 as shown in FIG. 3.

The plate portion 15 has a front surface 15a opposed to the recess 8 of the end surface 7. The front surface 15a has a recess 20 formed therein. The recess 20 is a concave surrounding the opening 19 and disposed in a middle portion of the plate portion 15. The recess 20 has a bottom 20a that is flat along the front surface 15a.

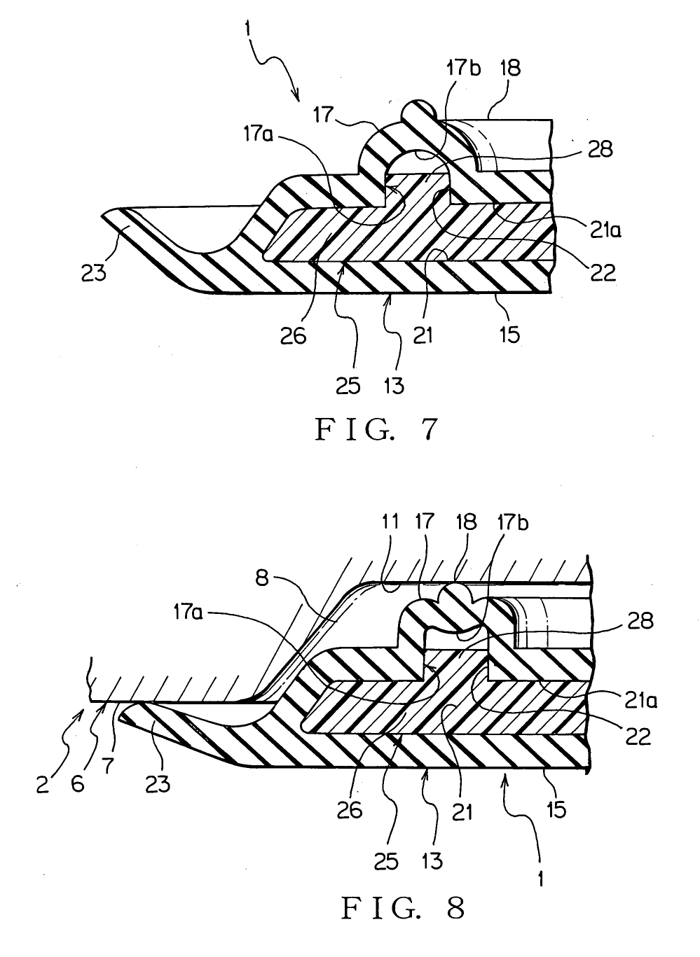

As shown in FIGS. 4 and 7, an extended hollow portion 21 is provided outward from a peripheral surface 20b positioned above the bottom 20a of the recess 20. The extended hollow portion 21 is extended outward along the surface 15a of the plate portion 15.

The plate portion 15 has an outer end formed with an outer lip 23. The outer lip 23 abuts against the end surface 7 of the door 2 to seal the end surface 7 to keep watertightness.

The tube 16 is defined in bellows and has an end connected to a periphery surrounding the opening 19 of the plate portion 15 such that the tube 16 is contiguous with the opening 19. The tube 16 is contiguous with a rear surface 15b (FIG. 2) of the plate portion 15. The tube 16 is extended from the rear surface 15b of the plate portion 15 to come away from the rear surface 15b. The tube 16 and the opening 19 receive the wiring harness 3 passing through them.

The hollow portion 17 is provided so as to surround the recess 20 of the plate portion 15. The hollow portion 17 is projected toward the recess 8. The hollow portion 17 has an arch-shaped section such that the hollow portion 17 defines a channel 22 in an inner surface 21a (FIG. 7) of the extended hollow portion 21. The hollow portion 17 is provided all over the plate portion 15 except an inner periphery of the plate portion 15.

The lip 18 has a convex shape projecting from an outer surface of the hollow portion 17 toward the recess 8 defined by the end surface 7 of the door 2. The lip 18 is projected perpendicular to the hollow portion 17 and the end surface 7 of the door 2. That is, the hollow portion 17 is positioned between the lip 18 and the plate portion 15.

The lip 18 is positioned around the recess 20. The lip 18 surrounds an inner grommet 14 attached to the grommet main body 13. The lip 18 has an arc-shaped outer surface. When the grommet 1 is attached to the recess 8, the lip 18 abuts against an inner surface of the shallow recess 11 to seal the shallow recess 11 to keep watertightness. That is, the lip 18 abuts against the door panel 6 to seal the door panel 6 to keep watertightness.

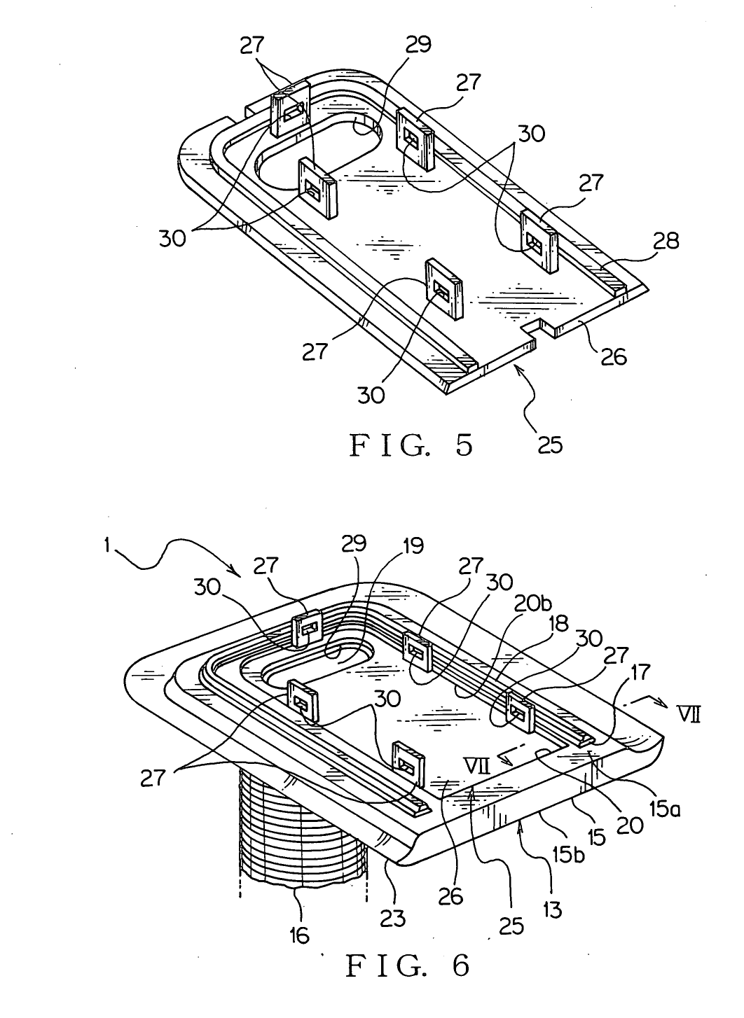

As shown in FIGS. 4 and 7, the plate portion 15 is fitted with a compensation piece 25 of a substantially flat plate made of a synthetic resin. The synthetic resin is a harder material than elastic one such as rubber to resist to elastic and plastic deformation. As shown in FIG. 5, the compensation piece 25 has a plate-shaped main part 26, a plurality of locking pieces 27, and a projection 28. A plan profile of the main part 26 is substantially equal to that of the plate portion 15. The main part 26 has an opening 29.

The main part 26 has an outer peripheral portion forced into the extended hollow portion 21 and rests on the plate portion 15. The opening 29 communicates with both the opening 19 and the tube 16 after the main part 26 is attached to the plate portion 15.

The plurality of locking pieces 27 rise from the main part 26. The locking pieces 27 are positioned in the recess 20 formed in the plate portion 15 when the main part 26 is attached to the plate portion 15. The locking piece 27 has an aperture 30 (shown in FIGS. 5 and 6) to engage with a locking protrusion 33 discussed later of the inner grommet 14. The engagement of the protrusion 33 with the aperture 30 locks the protrusion 33 to the locking piece 27.

The projection 28 rises from a surface near the end surface 7 of the main part 26. The projection 28 advances into the hollow portion 17 when the main part 26 is attached to the plate portion 15. The projection 28 is extended over the whole length of the hollow portion 17. The projection 28, as shown in FIG. 7, is spaced from a surface 17b of an inner surface 17a near the lip 18 as shown in FIG. 7, when the projection 28 has advanced into the hollow portion 17. That is, there is a clearance between the projection 28 and the inner surface 17b of the hollow portion 17.

The compensation piece 25 positions the wiring harness 3 to extend it on the main part 26 in the side of the end surface 7 of the door 2.

The inner grommet 14 is made of a hard synthetic resin and has a housing 31, a harness guide 32, a plurality of locking protrusions 33, and a plurality of second locking pieces 34 as shown in FIGS. 3 and 4. The housing 31 has a bottom wall 37 and a plurality of peripheral walls 36 raised from an outer periphery of the bottom wall 37. The bottom wall 37 defines a trough in section. The bottom wall 37 has a rectangular plan profile, which is substantially equal to a plan shape of the shallow recess 11.

There are provided three of the peripheral walls 36. The peripheral walls 36, after the grommet 1 is attached to the end surface 7, is extended on two peripheral parts spaced from each other vertically to the bottom wall 37 and on an outer periphery positioned in a vehicle side of the bottom wall 37. That is, the peripheral wall 36 is provided over the periphery of the bottom wall 37 except the inner side of the vehicle. The plurality of peripheral walls 36 are raised from the bottom wall 37 parallel to each other.

Thus configured housing 31 is arranged such that the bottom wall 37 is spaced from the main part 26 of the compensation piece 25. The housing 31 positions the wiring harness 3 passing through the tube 16 in a space surrounded by the bottom wall 37 and the peripheral wall 36. Thereby, the inner grommet 14 positions the wiring harness 3 on the bottom wall 37.

The harness guide 32 has a plurality of peripheral walls 37 raised from a top wall 35 of the housing 31 in an opposite direction with the peripheral wall 36. These peripheral walls 37 are raised from an outer periphery of the top wall 35 in a region where no peripheral wall 36 is provided. The harness guide 32 positions the wiring harness 3, which is arranged between the grommet main body 13 (discussed later) and the housing 31 of the inner grommet 14, along the peripheral walls 37 to guide it into an inner side of the door panel 6.

The plurality of locking protrusions 33 rise outward from an outer surface of the peripheral wall 36. These locking protrusions 33 are spaced from each other. The locking protrusions 33 engage with the apertures 30 to lock the locking pieces 27.

The second locking piece 34 projects from the bottom wall 37 of the housing 31 toward the recess 8 oppositely with the peripheral wall 36. The second locking piece 34 engages with the hole 12 penetrating through a bottom of the recess 8.

A fore end of the peripheral wall 36 is opposed to the main part 26 of the compensation piece 25 attached to the plate portion 15 of the grommet main body 13, and the fore end comes close to the grommet main body 13. Thereby, thus configured inner grommet 14 is attached to the grommet main body 13. Hence, the inner grommet 14 and the grommet main body 13 are secured to each other. As discussed above, the housing 31 is attached to the grommet main body 13 and the second locking pieces 34 are locked in the holes 12, so that the inner grommet 14 is attached to both the plate portion 15 of the grommet main body 13 and the deep recess 10 of the door panel 2.

Thus configured grommet 1 is assembled as discussed below and attached to the door 2. First, a periphery of the main part 26 of the compensation piece 25 is forced into the extended hollow portion 21 of the plate portion 15 of the grommet main body 13. Then, the plate portion 15 is overlaid on the main part 26 to secure the compensation piece 25 to the plate portion 15. The wiring harness 3 is introduced through the tube 16 to position the wiring harness 3 on the plate portion 15 of the grommet main body 13.

The inner grommet 14 is moved to come close to the grommet main body 13 while the bottom wall 37 of the peripheral wall 36 is opposed to the compensation piece 25. Then, the locking protrusions 33 are locked to the locking pieces 27. Thus, the wiring harness 3 is arranged between the grommet main body 13 and the inner grommet 14.

Then, the wiring harness 3 is arranged along the bottom wall 37 of the harness guide 32 and is secured to the bottom wall 37 by winding them with a tape together. The grommet 1 is thus assembled and attached to the wiring harness 3.

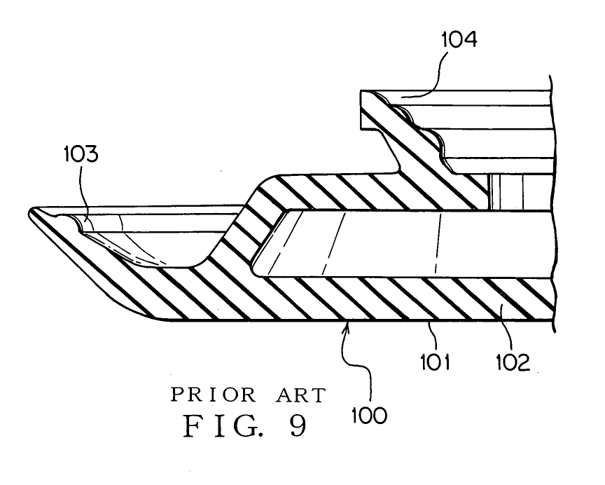

Then, the second locking piece 34 is engaged with the hole 12 of the door panel 6 to attach the grommet 1 to the door panel 6. Thereby, as shown in FIG. 8, the outer lip 23 contacts the door panel 6 and a periphery of the plate portion 15 resiliently deforms to come away from the door panel 6, while the lip 18 contacts the tube 16 and the hollow portion 17 yieldingly deforms so that the inner surface 17b comes toward the compensation piece 25. Thus, the lips 23 and 18 seal the door panel 6 to keep watertightness.

The connectors 5a and 5b of the wiring harness 3 are coupled to associated ones, and the wiring harness 3 is arranged between the vehicle main body and the door 2. The wiring harness 3 electrically connects another wiring harness provided in the vehicle main body to various types of electronic instruments disposed in the door 2.

Thus, the lips 23 and 18 seal the door panel 6 to keep watertightness, so that the wiring harness 3 arranged between the grommet main body 13 and the inner grommet 14 is protected from external water.

In the embodiment, the hollow portion 17 has a section, each end of which is contiguous with the plate portion 15, and the hollow portion 17 supports the lip 18. Thus, each end of the hollow portion 17 presses the lip against the door panel 6 with the lip therebetween. Since the lip 18 is supported by the hollow portion 17 of a two leg type, the lip 18 can resist to its displacement disengaging from the door panel 6 more than a conventional lip of a cantilevered type.

Therefore, the lip 18 can keep engagement with the door panel 6 even when pressurized water acts on the sealing portion having the lip 18, surely preventing the pressurized water from entering via the lip 18.

The compensation piece 25 has the projection 28 advancing into the hollow portion 17 so that the hollow portion 17 further resists to undesirable yielding thereof. Thus, the hollow portion 17 surely presses the lip 18 against the door panel 6 so that the lip 18 can always contacts the door panel 6. Therefore, the lip 18 can keep engagement with the door panel 6 even when pressurized water acts on the sealing portion having the lip 18.

A space between the projection 28 and the inner surface 17b of the hollow portion 17 allows an appropriate resilient deformation of the hollow portion 17, so that the lip 18 deforms to move from and toward the hollow portion 17. The comparatively free deformation of the lip 18 provides a contact force uniform over the whole length of the lip 18. Thus, even a weak point of the lip 18 is prevented from intrusion of the pressurized water. That is, the lip 18 can contact reliably the door panel 6 over the whole length of the lip 18.

The convex surface of the lip 18 provides a reduced contact surface against the door panel 6 so that the lip 18 gives a higher contact pressure per a unit area to the door panel 6. Therefore, the lip can contact the door panel 6 more reliably with ease.

The grommet 1 has the grommet main body 13 provided with the lip 18 and the hollow portion 17, preventing the pressurized water from entering via the lip 18 inside the door 2.

In the embodiment, the grommet 1 is attached to the door panel 6. Of course, the grommet 1 according to the present invention may be applied to another panel of the vehicle other than the door panel 6. In the invention, another configuration may be adopted to the locking protrusion 33, the locking piece 27, and the second locking piece 34.

The discussed embodiment applies the grommet main body 13 as a sealing member. However, the grommet 1 may be applied to a member other than the grommet main body 13. The prevent invention may be applied to various types of sealing members for sealing members other than the door panel 6.

In the invention, the projection 28 may be divided into a plurality of pieces longitudinally spaced from each other. The compensation piece 25 may be integrally formed with the plate portion 15 of the grommet main body 13 in insert molding.

The discussed embodiment is a representative aspect of the present invention that is not limited in the embodiment. The present invention can provide various modified embodiments within the spirit of the invention.

What is claimed is:

1. A sealing member (12) comprising:
a main body (15),
a lip (18) contacting an opposite member (6) to seal the opposite member to keep watertightness between the main body and the opposite member, and
a hollow portion (17) positioned between the main body and the lip, the hollow portion defined unitarily with the main body and the lip, the hollow portion having one end and an opposed end that are contiguous with the main body.

2. The sealing member recited in claim 1 further comprising a compensation piece (25) attached in the main body and made of a hard material, wherein the compensation piece has a projection (28) engaged with the hollow portion such that the projection is positioned adjacent to the hollow portion.

3. The sealing member recited in claim 1 wherein the lip has a convex surface projecting from the hollow portion toward the opposite member.

4. A grommet comprising the sealing member recited in claim 1, wherein the grommet is attached to a door of a motor vehicle for preventing a wiring harness arranged between the door and a body of the vehicle from contacting an external liquid, and the lip of the sealing member seals the door to keep watertightness between the door and the sealing member.
